(19) United States
(12) Patent Application Publication
(10) Pub. No.: US 2005/0017936 A1
(43) Pub. Date: Jan. 27, 2005

(54) Non-symmetrical drive method for LCD monitor

(76) Inventor: Li-Yi Chen, Zhu-Shan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/885,407

(22) Filed: Jul. 6, 2004

(30) Foreign Application Priority Data
Jul. 25, 2003 (TW) 092120460

(51) Int. Cl. G09G 3/36

(52) U.S. Cl. 345/87

(57) ABSTRACT

A drive method for driving a pixel of a non-symmetrical LCD monitor. The pixel has charging time divided into first sub-charging time and second sub-charging time. First, the pixel is driven by the first drive voltage at the first sub-charging time. Then, the pixel is driven by the second drive voltage at the second sub-charging time. The first drive voltage is greater than the second drive voltage, and the first sub-charging time is shorter than the second sub-charging time.

This application claims the benefit of Taiwan application Serial No. 092120460, filed Jul. 25, 2003, the subject matter of which is incorporated herein by reference.

### BACKGROUND OF THE INVENTION

1. Field of the Invention

The invention relates to a drive method for a LCD (Liquid Crystal Display) monitor, and more particularly to a non-symmetrical drive method for a LCD monitor.

2. Description of the Related Art

With the progress and creation of the technology, the display technology has been greatly developed. Taking a monitor as an example, the conventional CRT (Cathode Ray Tube) monitor has been gradually faded out in the high level monitor market owing to its big volume and serious radiation. Instead, miniaturized flat panel displays, such as a LCD, an organic light emitter diode (OLED) monitor or a plasma display panel (PDP) having low radiation and low power consumption, have been gradually developed.

The monitor of a display is composed of a plurality of bright spots arranged in a matrix, and the bright spots are referred to as pixels. The pixel is the most basic unit in the monitor. A drive voltage for determining the display brightness of each pixel is generated according to the pixel data inputted to the monitor. The monitor displays a frame according to a horizontal synchronal signal Hs and a vertical synchronal signal Vs. The horizontal synchronal signal Hs may decide the number of rows of pixels for displaying colors per second. When the pixels corresponding to the input pixel data are the last row of the pixels of the monitor, the vertical synchronal signal Vs controls to turn back to the first row of pixels of the monitor and to display the frame according to the pixel data. Hence, the vertical synchronal signal Vs may decide the display time for each frame, and the time interval between two adjacent vertical synchronal signals is defined as the frame time.

Because the human eye possesses the phenomenon of persistence of vision, if the refresh speed of the frame of the monitor is greater than a predetermined level, the rapidly refreshing frames viewed by the human eye are rapid flicker frames. The speed of refreshing different frames on the monitor is referred to as a refresh rate, which corresponds to the frequency of the vertical synchronal signal Vs. At present, the frame refresh rate of the typical computer host is above 60 Hz. That is, the monitor can display at least 60 sets of frame data, and each frame time is below 16.7 ms. Taking the LCD monitor with the resolution of 1024×768, the charging time for each pixel is 16.7 ms/768=22 us.

In the LCD monitor, each pixel includes liquid crystal. The transparency T of the liquid crystal of the pixel with respect to the light is changed according to the drive voltage applied to the pixel such that the pixel may represent different brightness. Because the response time of the liquid crystal is longer, the transparency of the liquid crystal cannot reach the desired target transparency TD corresponding to the target drive voltage VD immediately after the drive voltage has reached the target drive voltage VD. FIG. 1A is a graph showing the drive voltage of the pixel (i,j), wherein the horizontal axis denotes the time t. The drive voltage applied to the pixel (i,j) quickly rises to the target drive voltage VD. FIG. 1B is a graph showing the transparency T of the pixel (i,j) according to the drive voltage of FIG. 1A. The transparency T of the liquid crystal of the pixel (i,j) does not rise until the drive voltage is applied to the pixel (i,j). However, it takes a long period of rise time t1 to reach the target transparency TD.

Conventionally, the method for accelerating the response speed of the liquid crystal is to, for example, provide an over-drive voltage Vo higher than the target drive voltage VD, so as to shorten the rise time for the liquid crystal to reach the target transparency TD. FIG. 2A is a graph showing the drive voltage of the pixel (i,j) when the over-drive voltage Vo is applied thereto. FIG. 2B is a graph showing the transparency T of the liquid crystal of the pixel (i,j) according to the drive voltage of FIG. 2A, wherein the target transparency TD may be reached at time t2. It can be understood, from the drawings, that the provided over-drive voltage Vo may shorten the response time of the liquid crystal. However, the magnitude of the over-drive voltage Vo cannot be easily controlled. If the over-drive voltage Vo is too high, the final transparency T might be greater than the target transparency TD; and if the over-drive voltage Vo is too low, the response speed of the liquid crystal cannot be sufficiently increased.

In addition, the over-drive method can only take the refresh rate as the upper acceleration limit, so the refresh rate must be increased if the acceleration is to be further increased. Hence, the charging time of each pixel would be greatly shortened, the dimension of the thin film transistor has to be enlarged, and the gate line of the scan line has to be widened so that the impedance may be reduced. However, the aperture ratio will be reduced accordingly.

### SUMMARY OF THE INVENTION

It is therefore an object of the invention to provide a drive method capable of shortening the response time of the LCD monitor.

The invention achieves the above-identified object by providing a drive method for non-symmetrically driving a pixel of a LCD monitor. The pixel has charging time divided into first sub-charging time and second sub-charging time. First, the pixel is driven by the first drive voltage at the first sub-charging time. Then, the pixel is driven by the second drive voltage at the second sub-charging time. The first drive voltage is greater than the second drive voltage, and the first sub-charging time is shorter than the second sub-charging time.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a graph showing a drive voltage of a pixel.

FIG. 1B is a graph showing the transparency of the pixel according to the drive voltage of FIG. 1A.

FIG. 2A is a graph showing a drive voltage of a pixel when an over-drive voltage is applied to the pixel.

FIG. 2B is a graph showing the transparency of the pixel according to the drive voltage of FIG. 2A.

FIG. 3 is a flow chart showing a non-symmetrical drive method for a LCD monitor according to a preferred embodiment of the invention.

FIG. 4 is a graph showing a drive voltage of a pixel.

FIGS. 5A and 5B are graphs showing the transparency of the pixel.

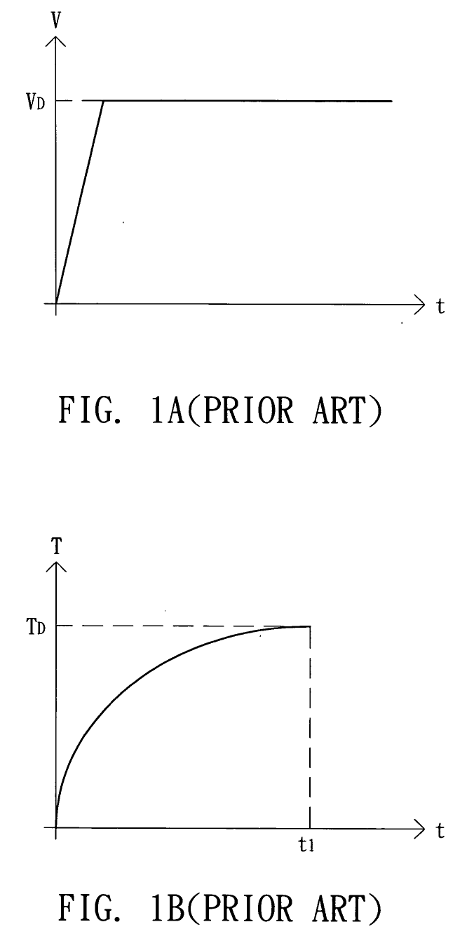

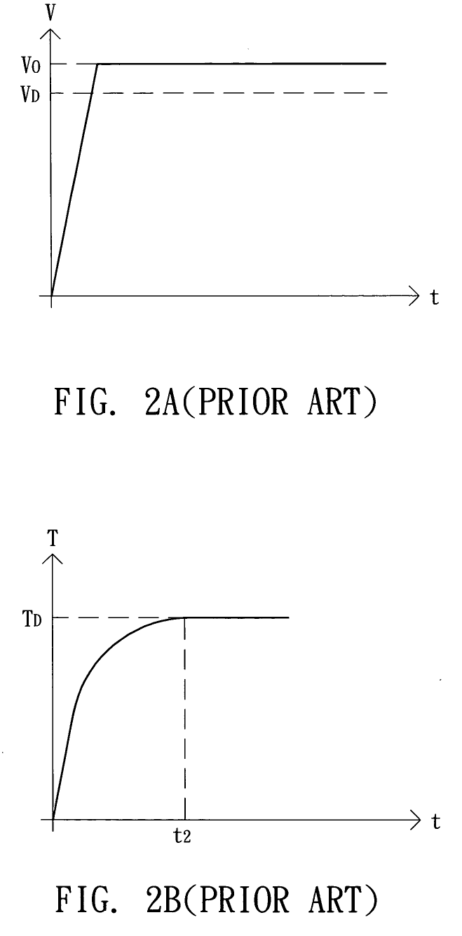

### DETAILED DESCRIPTION OF THE INVENTION

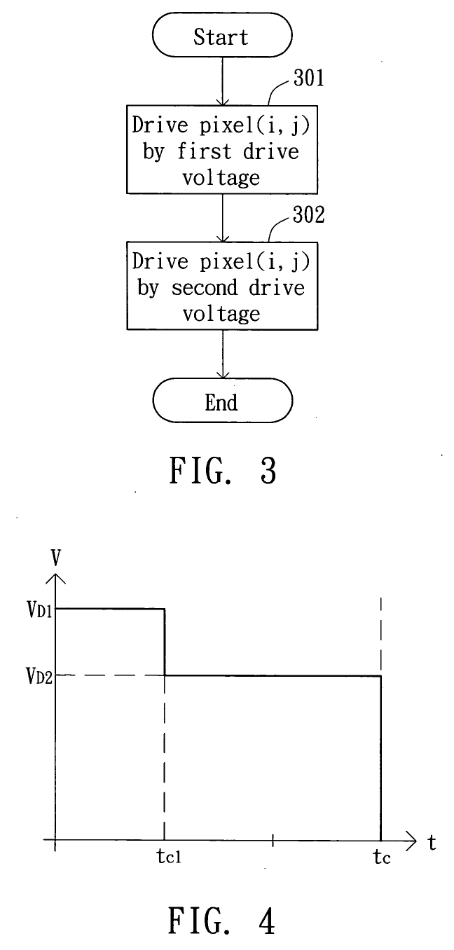

The spirit of the invention is to non-symmetrically divide the charging time of a pixel into two portions including first sub-charging time and second sub-charging time. FIG. 3 is a flow chart showing a non-symmetrical drive method for a LCD monitor according to a preferred embodiment of the invention. Taking a LCD monitor with the resolution of 1024×768 and the refresh rate of 60 Hz as an example, the same row of pixels are charged at each time, so the charging time tc of one pixel is (1/60)/768=22 us. An example of driving one pixel (i,j) of the LCD monitor will be illustrated, wherein i is a positive integer smaller than or equal to 1024, and j is a positive integer smaller than or equal to 768. Please also refer to the graph of the drive voltage of FIG. 4. The first sub-charging time is time tc1, and the second sub-charging time is from time tc1 to time tc. First, in the first sub-charging time, the pixel (i,j) is driven by the first drive voltage V_{D1}, as shown in step 301. Next, in the second sub-charging time, the pixel (i,j) is driven by the second drive voltage V_{D2}, as shown in step 302.

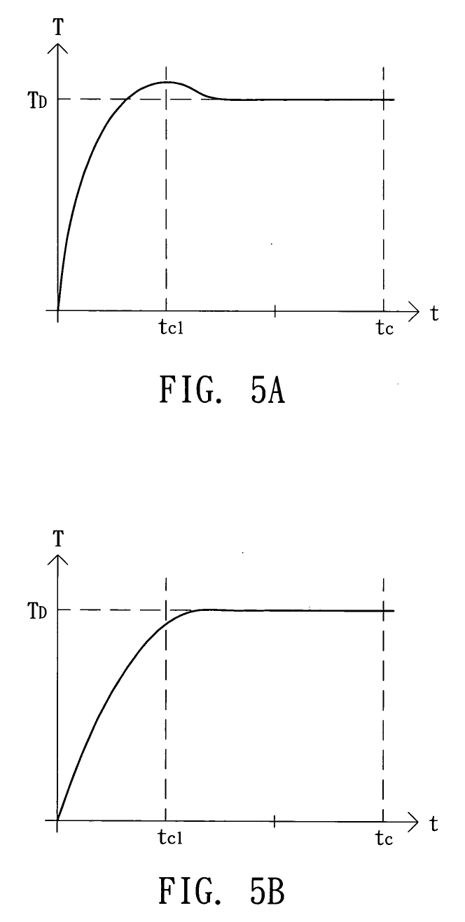

FIGS. 5A and 5B are graphs showing the transparency of the pixel. The ratio of the first sub-charging time to the second sub-charging time in this embodiment is 1:2. In FIG. 5A, the first drive voltage V_{D1} is such that the maximum transparency of the pixel is greater than the target transparency TD. In FIG. 5B, the first drive voltage VD_{D1} is such that the maximum transparency of the pixel is smaller than the target transparency TD. Although the curves of transparency T of FIGS. 5A and 5B are different, the display effects of the pixels with respect to the human eye may be regarded as the same. The first drive voltage VD_{D1} in the first sub-charging time is for determining the response time of the liquid crystal of the pixel and the response time is too short to greatly influence the feeling of the human eye. Therefore, it is enough as long as the first drive voltage V_{D1} is such that its corresponding transparency has the accuracy of 90%. The second sub-charging time is longer and its second drive voltage V_{D2} may therefore determine the transparency of the liquid crystal of the pixel. Thus, the response time of the liquid crystal may be shortened without influencing the display quality in this invention.

The non-symmetrical drive method for the LCD monitor according to the embodiment of the invention may shorten the response time of the liquid crystal without influencing the display quality. In addition, it is unnecessary to modify the designs (the gate line, or the dimension of the thin film transistor) of the liquid crystal panel, so the research and development speed may be accelerated.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method for non-symmetrically driving a pixel of a LCD (liquid crystal display) monitor, the pixel having charging time divided into first sub-charging time and second sub-charging time, the method comprising the steps of:
driving the pixel by a first drive voltage at the first sub-charging time; and
driving the pixel by a second drive voltage at the second sub-charging time, wherein
the first drive voltage is greater than the second drive voltage, and the first sub-charging time is shorter than the second sub-charging time.

2. The method according to claim 1, wherein a time ratio of the first sub-charging time to the second sub-charging time is 1:2.
